(19) United States
(12) Patent Application Publication
(10) Pub. No.: US 2005/0198565 A1
(43) Pub. Date: Sep. 8, 2005

(54) Method and apparatus for automatic update ad notification of documents and document components stored in a document repository

(76) Inventor: Peter S. McChrystal, Indialantic, FL (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 11/061,093

(22) Filed: Feb. 19, 2005

Related U.S. Application Data
(60) Provisional application No. 60/546,528, filed on Feb. 20, 2004.

(51) Int. Cl. G06F 17/00

(52) U.S. Cl. 715/511

(57) ABSTRACT

A method and apparatus for updating user-created derivative information components derived from source information components stored in a repository. A client-side automatic update and notification engine compares metadata tags associated with the derivative information components with metadata tags associated with the source information components and provides the user with options to update the outdated derivative information components automatically or on command.

This application claims the benefit of U.S. Provisional Patent Application No. 60/546,528, filed on Feb. 20, 2004.

### FIELD OF THE INVENTION

This invention relates generally to documents and document components stored in a repository for use by a plurality of users, and more specifically to a method and apparatus for automatically updating and/or providing update notifications for locally-stored documents derived from the repository-stored documents and document components.

### BACKGROUND OF THE INVENTION

In today's business environment employees use computers to create many different document types, and during any workday each employee creates many such documents. Document types include text files, presentation files, database files and spreadsheets. In a business enterprise, the documents can be stored locally on an individual employee's computer storage media (such as a hard disc drive) or stored on one or more file servers accessible to all employees. The documents stored on the file servers can be revised by the author or another employee contributor. To accomplish the revision, the document is downloaded from the server to the employee's computer, revised and then uploaded back to the server. Alternatively, the employee may revise the document and store it locally. To prevent unwanted document revisions, it is known that certain document attributes can be established to permit revisions by designated employees only.

In a typical business organization, after a source document is created, other members of the organization rely on its contents for creating derivative documents. For example, a controller consults the spreadsheet prepared by an accounting manager to create a financial report for senior management. An engineer relies on a component price set forth in a database document prepared by a buyer, for use in preparing a customer proposal. Although widespread availability and use of these documents is crucial to the organization' mission, it is recognized that modification of a source document will not be captured by a derivative document prepared prior to the modification. Thus, before an employee can finalize his document, he must check the source document one last time to ensure that it has not been modified.

### BRIEF SUMMARY OF THE INVENTION

A first embodiment of the present invention comprises a method for updating derivative information components derived from source information components, wherein from time to time one or more of the source information components is modified. The method comprises: creating source tags for each of the source information components; creating derivative tags from the source tags; wherein the source tags are modified whenever a corresponding source information component is modified; determining whether one or more of the derivative information components differs from the source information component from which the derivative information component was derived by comparing the source tags and the derivative tags; updating one or more of the derivative information components that differ from the source information component due to a modification of the source information component and updating the derivative tags.

Another embodiment of the present invention comprises an apparatus for updating derivative information components stored at a user's computer and derived from source information components stored in a repository, wherein from time to time one or more of the source information components is modified. The apparatus comprises a first software module for creating source tags in response to the source information components and storing the source tags in the repository; and a second software module at the user's computer for creating derivative tags in response to the derivative information components, for determining whether one or more of the derivative information components differs from the source information component from which the derivative information component was derived by comparing the source tags and the derivative tags and for updating the derivative information component according to a modification of the source information component.

### BRIEF DESCRIPTION OF THE DRAWINGS

The present invention can be more easily understood and the further advantages and uses thereof more readily apparent, when considered in view of the following detailed description when read in conjunction with the following figures, wherein:

FIG. 1 illustrates operation of the present invention in block diagram form.

FIG. 2 is a flowchart illustrating steps for carrying out the teachings of the present invention.

In accordance with common practice, the various detailed features are not drawn to scale, but are drawn to emphasize specific features relevant to the invention. Like reference characters denote like elements throughout the figures and text.

### DETAILED DESCRIPTION OF THE INVENTION

Before describing in detail the particular method and apparatus for automatic notification and updating of documents in accordance with the present invention, it should be observed that the present invention resides primarily in a novel combination of hardware and software elements. Accordingly, so as not to obscure the disclosure with details that will be readily apparent to those skilled in the art having the benefit of the description herein, in the description that follows, certain hardware and software elements have been described with lesser detail, while the drawings and specification describe in greater detail other elements and steps pertinent to understanding the invention. The following embodiments are not intended to define limits as to the structure or use of the invention, but only to provide exemplary constructions. The embodiments are permissive rather than mandatory and illustrative rather than exhaustive.

The present invention provides the capability to update a locally stored derivative document (i.e., information file or file) that was derived from a source document stored in a document repository (i.e., a digital library), in response to source document revisions that were made after creation of the derivative document. To accomplish the update process, the digital library of the present invention augments the document with pertinent content information about the document and its components, thereby providing document management capabilities not found in prior art central file repositories that are controlled by known computer operating systems or software applications.

In a prior art central (i.e., accessible to a plurality of users) content (file or document) repository (central file server), the operating system or a dedicated file-based document management system provides file management capabilities. The repository is sometimes referred to as a “digital library” because it comprises a collection of digital files in an organized file structure. It is known that a prior art digital library or digital library system can provide added-value for each element of digital information stored in the library. Examples include the capability to view thumbnails of various documents, to view thumbnails of pages within a document, to search inside the documents and return document components and to add metadata to the documents or document components. In short, the digital library and its controlling software take the management of digital files and information to a higher level of utility. In most applications, the library is further optimized to serve a specific business process (i.e. support a sales team with digital sales literature and materials, or provide engineering with a searchable repository of architectural drawings).

According to the present invention, which comprises a client-driven process in a preferred embodiment, when a user opens a locally-stored derivative file (or a file component) that was derived from a source file (or a file component) stored in the digital library, a background process (as controlled by a client-side plug-in software application also referred to as an automatic notification and update engine) checks the file (or the file component) stored locally against the source version stored in the library. Specifically, tags (metadata) in the derivative document are compared with metadata in the source document. If the tag comparison process indicates that a more recent version of the file (or the file component) exists in the library, the user is notified and offered an opportunity to update the derivative file or one or more of its component (individually) from the source file in the digital library. The user can update the entire derivative document or select only certain components for updating.

The engine can communicate with the repository over any network type, including a local area network, a wide area network or the Internet, including both wired or wireless networks. Thus the engine can query the repository over any conventional network.

There are several advantages to the approach of the present invention. First, because the process is client-driven, the digital library system is queried only when clients are preparing to use information that may be outdated, i.e., only when the user opens a derivative documents derived from a source document in the repository. Second, the user will not receive a notification each time a source document stored in the digital library is updated (referred to as server-side push and provided by known document management systems), but instead only when she is preparing to utilize a file or file component that was derived from a source document stored in the digital library. Third, the present invention provides update notifications for granular file components of the derivative document, i.e., for updates to the source document components that have been used to create a locally-stored derivative document. For example, if a user had created a presentation including three slides downloaded from the library, and five slides gathered from his local hard drive, the update process of the present invention allows the user to update any or all of the three slides that originated from the library without affecting the other slides in the presentation.

Thus the present invention provides component-by-component derivative document updating only for file components that have been updated in the source document since the derivative document was created. The updating is accomplished without disturbing those derivative document components that have not been updated in the source document since creation of the derivative document, and without disturbing derivative document components that were not derived from the source document. Finally, the process of the present invention tracks the user's download of files and files components from the library to the user's local computer for use in creating derivative documents. Reports based on this tracked data detail: file and file component updates made by users to locally stored documents derived from library-stored documents, updates that were refused by the user, and in both cases, the user's identity.

According to the teachings of the present invention, information files stored in the repository are segregated into individual components or sub-files. Components can include individual slides from a multi-slide presentation document, pages or paragraphs from a text document, objects (e.g., charts, tables) embedded in a document, and files embedded in a document. The digital library system (also referred to as a librarian) stores a plurality of information elements (metadata or tags) about each information file and its components.

The system of the present invention also embeds information elements (tracking tags or metadata) in derivative documents and derivative document components that are stored locally (e.g., on a user's personal computer), where the derivative documents and document components are derived from source documents or source document components stored in the repository.

Using tags for both the source and the derivative documents, the system of the present invention recognizes derivative documents, i.e., content stored outside the library that at some time had been associated with and/or derived from a library-stored document or document component and compare the status of the derivative document and its components with the source document and its components. The embedded tags do not affect normal functionality or utility of the file or component, but allow the system of the present invention to perform file comparisons (e.g., a source file compared with its associated derivative file) and sophisticated updates beyond simply comparing the last-modified date of the source file with the last modified date of the derivative file, as is known in the prior art.

According to a preferred embodiment of the present invention, when a user opens her locally-stored derivative document after modification of the repository-stored source document, she is presented with options regarding updating the derivative document to reflect later modifications to the source document. She can update the entire derivative document or update only selected components of the derivative document. This feature provides more granular updates for the derived files. Also, this granular approach retains revisions made to the derivative document, as complete replacement of the derivative document with the modified source document causes the user to lose all revisions she has made to the derived document. The user is also given the option to individually update each derived document component derived from the source document, and can elect to update certain components while retaining other components in original form.

The teachings of the present invention can be applied to any document format, including documents prepared using Microsoft's Office® suite of applications (e.g., Excel, Word, PowerPoint, and Access), Adobe® portable document format, Adobe® Framemaker, Adobe® InDesign, Quark Express, Microsoft Project and Microsoft Visio or other known rich-media document formats.

According to a preferred embodiment, the automatic notification and update engine is embodied as a plug-in to a computer operating system and/or known applications running under that operating system. For example, the engine is suitable for use with Windows Explorer, Internet Explorer, the Microsoft Office® produce suite, and Adobe® applications including Adobe® Acrobat and Adobe® Reader.

The engine presents each user who creates a derivative file with a preference-setting option to receive a notification that a source file or source file component has been updated or to automatically update the user's derivative file based on modifications to the source file, whenever a user-configurable event occurs, at which time the engine queries the repository. The user-configurable events include: when the derivative file is opened, lapse of a user-selected period after downloading the source file from the repository and whenever the user invokes a command to check for derivative document component updates.

According to the first option, when a locally-stored derivative file is opened, the software engine determines whether the file was downloaded in its entirety from the library or whether the file contains components that were derived from the library. In either case, the engine automatically updates the derivative file or file components or notifies the user (e.g., with a pop-up dialog window) that the source file has been changed and prompts the user to do nothing, update one or more of the outdated derivative file components or update the entire derivative file. The user configures the engine to perform the automatic update or to provide the window notification.

When a user updates the derivative file and when the user receives the update notification, the transaction is logged in the repository for use in creating the use reports described above.

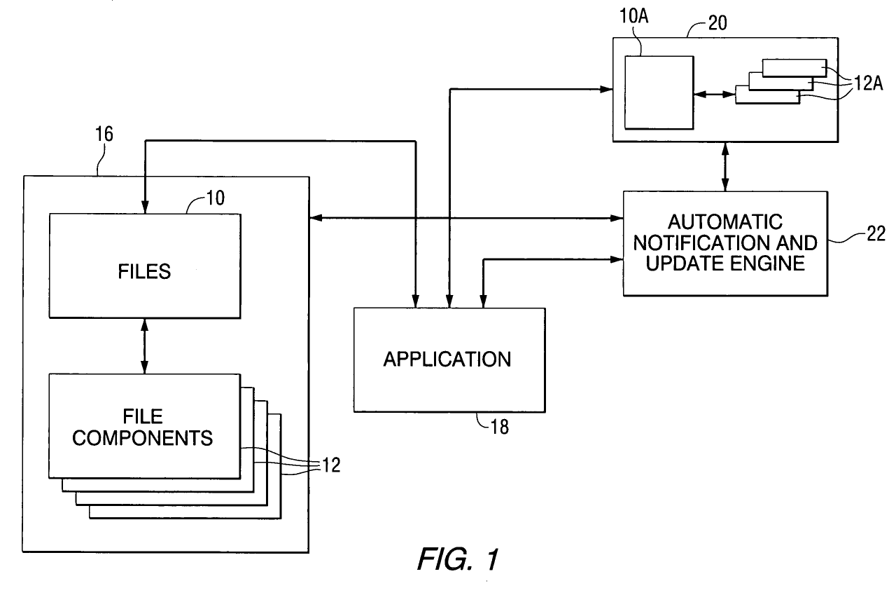

The teachings of the present invention are illustrated schematically in FIG. 1 where a source file 10 comprises a plurality of source sub-files or file components 12. The source file 10 was previously prepared and after preparation resides in a repository 16. A derivative file 10A (comprising derivative file components 12A), prepared by an application 18, incorporates the source file 10 or one or more of the source file components 12 and is stored in a local storage medium 20. An automatic notification and update engine 22 (a client-side plug-in or software module in a preferred embodiment) queries the repository 16 to identify file components 12 that have been modified since the last query, as described further below.

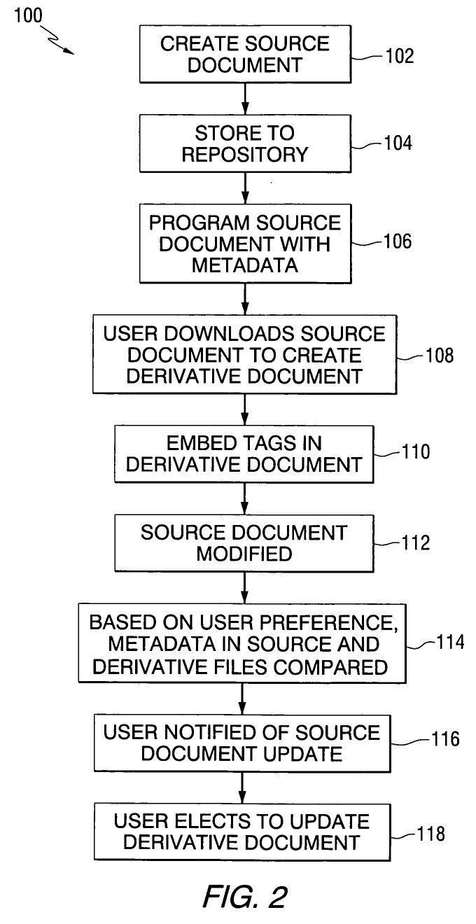

FIG. 2 is a flow chart 100 depicting the steps associated with a preferred embodiment of the present invention. In one embodiment, the FIG. 2 method is implemented in a microprocessor and associated memory elements within a client computer and/or within a repository. In such an embodiment the FIG. 2 steps represent a program stored in the memory element and operable in the microprocessor. When implemented in a microprocessor, program code configures the microprocessor to create logical and arithmetic operations to process the flow chart steps. The invention may also be embodied in the form of computer program code written in any of the known computer languages containing instructions embodied in tangible media such as floppy diskettes, CD-ROM's, hard drives, DVD's, removable media or any other computer-readable storage medium. When the program code is loaded into and executed by a general purpose or a special purpose computer, the computer becomes an apparatus for practicing the invention. The invention can also be embodied in the form of a computer program code, for example, whether stored in a storage medium loaded into and/or executed by a computer or transmitted over a transmission medium, such as over electrical wiring or cabling, through fiber optics, or via electromagnetic radiation, wherein when the computer program code is loaded into and executed by a computer, the computer becomes an apparatus for practicing the invention.

The FIG. 2 flow chart 100 begins at a step 102 where a source document is created and stored to the repository 16 at a step 104. When the source file 10 and its components 12 are imported into the repository 16, the file 10 and the file components 12 (objects) are parsed and encrypted (in one embodiment) characters/code strings (referred to as tags) are created to represent the state of the various aspects of the document/file and its components, including: properties, text, page objects, layout and background. See step 106. This list is merely exemplary and can be augmented with additional file and document aspects as desired. Copies of the encrypted strings are stored within the source file 10 and the file's components 12, as well as in the repository 16, as metadata associated with the file 10 and file components 12.

As depicted at a step 108, a user downloads the source document/components 10/12 from the repository 16 to a local computer storage device, to create the derivative document/components 10A/12A based thereon. As indicated at a step 110, the tags associated with the source file/components 10/12 are embedded in or stored locally and associated with the derivative file/components 10A/12A.

The source document is later modified as indicated at a step 112, causing one or more of the tags associated with the source document/components 10/12 to be accordingly modified.

The automatic notification and update engine 22 (see FIG. 1) compares the metadata associated with the source file with the metadata associated with the derivative file at a step 114. As described above, the comparison process is executed in accordance with user-configured parameters.

At a step 116, the engine 22 notifies the user if the derivative document/components are different than the source document/components, reflecting one or more modifications to the source document after preparation of the derivative document. No notification is provided if the derivative file metadata is aligned with the source file metadata. The notification comprises a simple notification that the source file and the derivative file do not match or a more detailed notification that advises specific differences between the source file and the derivative file.

At a step 118, the user elects to update the derivative document or one or more components of the derivative document as desired. The derivative document tags are then modified to reflect the updated derivative document components. The source document metadata remains unchanged. At this step, the engine 22 enters logging data that records whether or not the user elected to accept or reject the component update(s).

Although the teachings of the present invention have been described with respect to derivative documents and derivative document components stored locally, i.e., on a users local computer hard drive, for example, the present invention is not so limited. The derivative documents and derivative document components may be stored on a shared network drive or another public data storage device.

According to another embodiment, the user can command the engine 22 to update all derivative documents/derivative components within a user-selected number of downloading the document/components from the repository 16. For example, the user can configure the engine 22 to update all derivative documents/derivative document components that have been created (or downloaded from the repository 16) within the last thirty days.

According to yet another embodiment, the user can elect to receive a notification that source file components present in one or more of the user's derivative files have been updated in the repository 16. This notification can be provided by an email message sent by the engine 22 to the user's email address.

Further details of the file tagging process, using a PowerPoint® file as an example, are set forth below. When a PowerPoint file is imported in to the library 16, a set of three hashes (a triple hash) is calculated for every slide in the presentation. Each hash corresponding to structure, text and format specifiers of its associated slide. This hashing enables the engine 22 to find the slides that have similar structure, i.e., the same text and the same formatting or a combination of the above criteria. During this process the slide is tagged with metadata that assists the engine 22 in identifying the source of the slide, even after the slide is downloaded from the repository 16. The slide tag essentially consists of accountID, account name, libraryID, library name, fileID, file name and the triple-hash. Although the account name, library name and file name may be redundant, these identifiers are attached to the slide to enable other search features that provide information about the slide, without consulting the metadata stored in the repository 16. According to one embodiment, the tag is stored as a comment on the notes page of every slide. This location was selected because the comments on the notes page cannot be accessed through any interface with the PowerPoint® application, but can be accessed only programmatically. The tag is also stored in the repository 16.

Once the slide is downloaded to a local storage device for creating the derivative file, the source file can be found from the acctID, libraryID and fileID information.

To check for an updated version of the source slide stored in the repository 16, the engine 22 sends a message containing the triple-hash to the repository 16 for use in checking against the triple-hash tag stored in the repository. In response to the comparison, the engine 22 generates and transmits an appropriate message to the client computer (where the derivative file is stored).

One embodiment of the invention comprises a feature wherein the user of the derivative file/file component is asked whether the source file/file component in the repository 16 should be updated with the current derivative file/file component. This feature is implemented, for example, when the derivative file user is the author of the file. The user can be queried upon exiting or closing the derivative file. The engine 22 calculates the triple-hashes for the derivative file/file components and compares same against the tagged hashes stored with the source file/file components (without querying the repository 16). The engine 22 can quickly determine whether and which file components have been modified since the download by sending a message to the repository containing only the triple-hashes for checking against the current information in the repository 16.

According to one embodiment, each tag is about 150-200 bytes long, resulting in a small increase in each file size. According to another embodiment in which operating speed is not a critical consideration but storage space is limited, it is not necessary to store the hashes in the derivative file components. Instead the triple-hashes are calculated at the client each time the file component is opened. Although this embodiment reduces the derivative file size, the amount of data transferred across the network between the client and the repository increases.

While the invention has been described with reference to preferred embodiments, it will be understood by those skilled in the art that various changes may be made and equivalent elements may be substituted for elements thereof without departing from the scope of the invention. The scope of the present invention further includes any combination of the elements from the various embodiments set forth herein. In addition, modifications may be made to adapt a particular situation to the teachings of the present invention without departing from its essential scope. Therefore, it is intended that the invention not be limited to the particular embodiment disclosed as the best mode contemplated for carrying out this invention, but that the invention will include all embodiments falling within the scope of the appended claims.

1. A method for updating derivative information components derived from source information components, wherein from time to time one or more of the source information components is modified, the method comprising:
creating source tags for each of the source information components;
creating derivative tags from the source tags;
wherein the source tags are modified whenever a corresponding source information component is modified;
determining whether one or more of the derivative information components differs from the source information component from which the derivative information component was derived by comparing the source tags and the derivative tags;
updating one or more of the derivative information components that differ from the source information component due to a modification of the source information component; and
updating the derivative tags.

2. The method of claim 1 wherein the step of determining is executed in response to user determined preferences.

3. The method of claim 2 wherein the derivative information components comprise a derivative information file, and wherein the user determined preference comprises at least one of whenever the derivative information file is opened by the user and a predetermined time after creation of the derivative information file.

4. The method of claim 1 wherein the step of determining is executed at a client computing device.

5. The method of claim 4 wherein the client computing device comprises a plurality of computing applications, and wherein the step of determining is executed by a plug-in software module associated with one of the plurality of computing applications.

6. The method of claim 1 wherein a derivative information file comprises the derivative information components and the derivative tags.

7. The method of claim 1 wherein the derivative information components comprise a derivative information file and the source information components comprise a source information file, and wherein the derivative information file and the source information file comprise at least one of a text file, a media file, a database file, a PowerPoint® file and an image file.

8. The method of claim 1 wherein the step of updating the derivative information components further comprises automatically updating the derivative information component in response to a user preference.

9. The method of claim 1 wherein the derivative information components are stored on a client computing device, and wherein the step of updating the derivative information components further comprises requesting update permission from a user of the client computing device prior to updating the derivative information components.

10. The method of claim 1 wherein the derivative information components are stored on a client computing device and the source information components are stored in a repository accessible to a plurality of users.

11. The method of claim 10 wherein the repository comprises a server computing device in communications with the client computing device.

12. The method of claim 1 further comprising a step of storing the source tags with the source information components.

13. The method of claim 1 further comprising a step of storing the derivative tags with the derivative information components.

14. The method of claim 1 wherein the source components are stored in a repository, the method further comprising a step of storing the source tags in the repository.

15. The method of claim 1 wherein the source components comprise one or more of properties, text, objects, layout and background and the derivative components comprise one or more of properties, text, objects, layout and background.

16. The method of claim 1 wherein the step of notifying comprises prompting for updating each one of the derivative information components that differs from the source information component due to a modification of the source information component.

17. A method for updating a derivative information file having a plurality of derivative information components derived from a source information file having a plurality of source information components, wherein each one of the plurality of derivative information components is associated with one of the plurality of source information components, and wherein the source information file is stored in a repository, and wherein the derivative information file is stored in a client computing device, the method comprising:
creating metadata source tags associated with the source information file, wherein the source tags are modified whenever the source information file is modified;
storing the source tags in the repository;
creating the derivative information file based on the source information file;
creating metadata derivative tags based on the metadata source tags;
comparing the derivative tags with the source tags to determine whether the derivative information file is different from the source information file; and
notifying the client computing device if the derivative information file is different from the source information file.

18. The method of claim 17 wherein the step of creating metadata source tags further comprises creating metadata source component tags for each one of the plurality of source information components, wherein the step of creating metadata derivative tags further comprises creating metadata derivative component tags for each one of the plurality of derivative information components, and wherein the step of comparing further comprises comparing the source component tags and the derivative component tags to determine whether one of the plurality of derivative information components is different from the associated one of the plurality of source information components.

19. The method of claim 17 wherein the derivative tags are stored with the derivative information file in a user inaccessible area of the derivative information file.

20. The method of claim 17 wherein the source tags are stored with the source information file.

21. The method of claim 17 wherein the source components comprise one or more of properties, text, objects, layout and background and the derivative components comprise one or more of properties, text, objects, layout and background.

22. The method of claim 17 wherein the step of notifying further comprises sending an email message to the client computing device.

23. An apparatus for updating derivative information components stored at a user's computer and derived from source information components stored in a repository, wherein from time to time one or more of the source information components is modified, the apparatus comprising:
a first software module for creating source tags in response to the source information components and storing the source tags in the repository; and
a second software module at the user's computer for creating derivative tags in response to the derivative information components, for determining whether one or more of the derivative information components differs from the source information component from which the derivative information component was derived by comparing the source tags and the derivative tags and for updating the derivative information component according to a modification of the source information component.

24. A computer program product for updating derivative information components stored at a user's computer and derived from source information components stored in a repository, wherein from time to time one or more of the source information components is modified, the computer program comprising:
a computer usable medium having computer readable program code modules embodied in the medium for updating the derivative information components;
a computer readable first program code module for creating metadata source tags associated with the source information file, wherein the source tags are modified whenever the source information file is modified;
a computer readable second program code module for storing the source tags in the repository;
a computer readable third program code module for creating the derivative information file based on the source information file;
a computer readable fourth program code module for creating metadata derivative tags from the metadata source tags;
a computer readable fifth program code module for comparing the derivative tags with the source tags to determine whether the derivative information file is different from the source information file; and
a computer readable sixth program code module for notifying the client computing device if the derivative information file is different from the source information file.
